(19) United States
(12) Patent Application Publication
(10) Pub. No.: US 2006/0239661 A1
(43) Pub. Date: Oct. 26, 2006

(54) FREQUENCY DETECTION METHODS

(75) Inventors: Meng-Ta Yang, Jhunan Township (TW); Jin-Bin Yang, Sihu Township (TW); Yuh Cheng, Jhubei City (TW)

Correspondence Address: CONNOLLY BOVE LODGE & HUTZ LLP, P.O. BOX 2207, WILMINGTON, DE, 19899-2207, US

(73) Assignee: MEDIATEK INC., Hsinchu City (TW)

(21) Appl. No.: 10/907,962

(22) Filed: Apr. 22, 2005

(51) Int. Cl. H04N 5/781

(52) U.S. Cl. 386/126

(57) ABSTRACT

An upper slicing level and a lower slicing level are determined to slice an RF signal into an upper sliced signal and a lower sliced signal respectively. A maximum pulse width occurs in the upper sliced signal or the lower sliced signal during a predetermined period is detected, and compared to a maximum run-length according to a clock signal. The frequency of the clock signal is adjusted according to the comparison result.

### BACKGROUND OF THE INVENTION

1. Field of the Invention

The present invention relates to frequency detection methods, more particularly to methods of detecting the frequency of a reproduction signal read from an optical disc.

2. Description of the Related Art

A general reproduction apparatus for reading an optical disc such as a compact disc (CD) or a digital versatile disc (DVD) requires establishing synchronization with the signal read from the optical disc. Phase locked loop (PLL) is one of the popular circuitries for tracking the frequency of an input signal. The PLL generally includes a frequency detection block, a charge pump block, a phase detection block, a frequency divider, and a voltage control oscillator (VCO). The frequency detection block in the PLL measures and calculates the difference between the frequency of the clock signal and the input signal, such as a radio frequency (RF) signal read from the optical disc, and performs frequency tracking for minimizing the frequency difference.

The length of a recording mark or space can be less than 1 μm for high-density capacity optical discs, which induces serious ISI (inter symbol interference). FIG. 1 shows an exemplary waveform diagram illustrating a sliced signal obtained from slicing an RF signal according to a conventional frequency detection method. When the amplitude of the RF signal is less than a predetermined slicing level, the corresponding sample is detected as 0; otherwise, it is detected as 1. The sliced signal is obtained from continuously detecting the RF signal, as shown in FIG. 1. If the RF signal is an EFM (eight-to-fourteen modulation) signal recorded on a CD, the average edge-to-edge width of the raising intervals for the sliced signal is roughly 5.4T (T denotes a unit period of the clock signal). The detected edge-to-edge average width of an EFM signal read from a CD is thus expected to be 5.4T, and the frequency of the clock signal can be tuned accordingly. Furthermore, the frequency detection method can tune the frequency of the clock signal by measuring and comparing the maximum mark or space length of the RF signal in a predetermined period of time. For example, the maximum mark length recorded on a CD is 11T, and the maximum mark length recorded on a DVD is 14T. Marks corresponding to the maximum mark length typically occur in the sync marks recorded on the optical disc. In a case of frequency detection for a CD, if the measured maximum mark length is only 8T, the reproduction device will increase the frequency of the clock signal so that the measured maximum mark length counted by the clock signal is approximately 11T.

For a high-density capacity optical disc with serious ISI (inter-symbol interference) problems, the RF signal waveform is distorted and the aforesaid frequency detection and synchronization methods may be inadequate. FIG. 2 shows an exemplary waveform diagram illustrating a sliced signal derived from the conventional frequency detection method when the RF signal is seriously distorted by the ISI. Short recorded marks as shown in circles A′ and B′ induce rapid rises and falls in the corresponding RF signal as shown in circles A and B, and such rapid changes of the signal strength will not be reflected in the corresponding sliced signal if employing the conventional slicing method. The sliced signal misses the rapid changes (circles A′ and B′) of the actual channel bit, and may cause the reproduction device misjudges the maximum mark length.

### SUMMARY OF THE INVENTION

Methods for detecting the frequency of an RF signal read from an optical disc are provided. A control signal is generated based on the difference between the detected frequency and a target frequency to accelerate the frequency locking process.

An upper sliced signal and a lower sliced signal are generated by slicing an RF signal according to an upper and a lower slicing level respectively. A maximum pulse width derived from either the upper sliced signal or the lower sliced signal in a predetermined period is compared to a predetermined pulse width. The frequency of the clock signal is then adjusted according to the comparison result.

The position of pulses corresponding to maximum pulse widths within a predetermined period is detected. An interval between two detected pulses is designated as a pseudo-frame period if the detected pulses occur periodically. The frequency of the clock signal is adjusted based on the pseudo-frame period.

### BRIEF DESCRIPTION OF THE DRAWINGS

The invention will be described according to the appended drawings in which:

FIG. 1 shows exemplary waveforms illustrating a single-level slicing method;

FIG. 2 shows exemplary waveforms illustrating a single-level slicing method;

FIG. 3(a) shows exemplary waveforms illustrating an embodiment of the two-level slicing method for frequency detection;

FIG. 3(b) shows exemplary waveforms of the upper and lower sliced signals illustrating an embodiment of the two-level slicing method for frequency detection;

FIG. 4(a) shows an exemplary waveform illustrating an embodiment of the frequency detection method based on integration results of the sliced signal;

FIG. 4(b) is a block diagram of an area integration circuit in accordance with an embodiment of the frequency detection method.

FIG. 5 is a graph showing pulse-width versus time in accordance with an embodiment of the frequency detection method;

FIG. 6 is a graph showing pulse-width versus time in accordance with an embodiment of the frequency detection method;

FIG. 7 is a graph showing pulse-width versus time in accordance with an embodiment of the frequency detection method;

FIG. 8 is a detected pulse sequence diagram in accordance with an embodiment of the frequency detection method; and

FIG. 9 is a flow chart showing an embodiment of the frequency detection method.

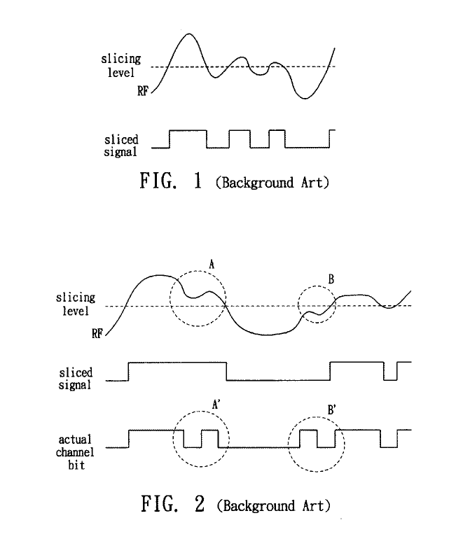

### DETAILED DESCRIPTION

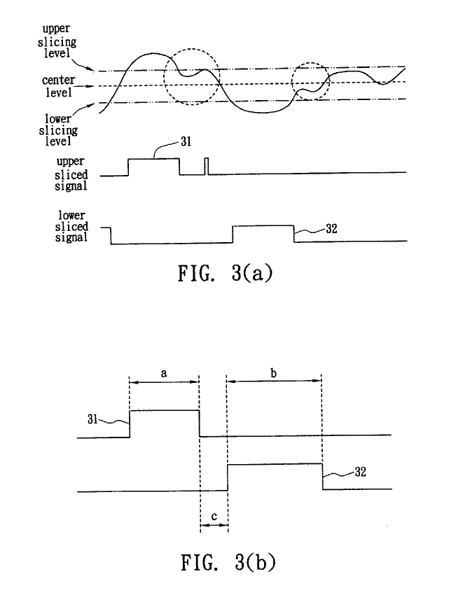

To overcome the problem of misjudging the maximum mark length due to rapid changes in an RF signal, the amplitude information of the RF signal is retrieved and utilized for frequency detection. There are various ways and alternatives for determining the maximum mark length and detecting the frequency of the RF signal based on the amplitude information of the RF signal. Two alternatives are demonstrated in the following description, one is to employ a two-slicing level method, and the other is to employ an integration method. In comparison with the conventional frequency detection method employing a single-level slicing method, two-level slicing method with upper and lower slicing levels is employed in an embodiment to shape an RF signal into two sliced signals. FIG. 3(a) illustrates an exemplary two-level slicing method for detecting the frequency of an RF signal. An upper sliced signal in a binary waveform expression is derived by slicing the RF signal with an upper slicing level, and similarly, a lower sliced signal in a binary waveform expression is derived by slicing the RF signal with a lower slicing level. As compared to the single-level slicing method as shown in FIG. 2, the lengths of pulses 31 and 32 derived from the upper and lower sliced signals in FIG. 3(a) are better approximations of the maximum pulse lengths of the actual channel bit. The circled rapid changes in signal strength can thus be recognized and distinguished from adjacent pulses.

FIG. 3(b) shows an exemplary upper and lower sliced signal derived from an RF signal read from a compact disc (CD). A first maximum pulse width “a” corresponding to pulse 31 is detected in the upper sliced signal over a predetermined period. In some embodiments, the predetermined period is 2 to 4 times the expected frame period. The first maximum pulse width “a”, counted by a clock signal, is compared with the duration of a predetermined pulse width. In some embodiments of the frequency detection method, the predetermined pulse width is the maximum run-length duration, which is the duration of a synchronization mark (sync mark), is 11T (T denotes a clock cycle) for CD or 14T for digital versatile disc (DVD). The first maximum pulse width in terms of clock cycle (T) is expected to be equal to the sync mark duration, if it is shorter than the sync mark duration, the frequency of the clock signal should be heightened; else the frequency should be lowered. In fact, two sync marks will be successively occurred in the RF signal read from a CD, so one maximum pulse width will be detected in the upper slicing level, and another will be detected in the lower slicing level.

In order to confirm the detected maximum pulse width, a second maximum pulse width “b” corresponding to pulse 32 is detected in the lower sliced signal over the predetermined period. Both the time gap “c” between the first and second maximum pulses and the difference |a−b| between the two maximum pulse widths should be relatively narrow if the two pulses are successive sync marks read from the CD. An interval between the start of pulse 31 and the end of pulse 32 (a+b+c) is regarded as two times the duration of the maximum run-length if both the time gap “c” and the difference |a−b| are less than preset thresholds. The frequency of the clock signal is adjusted by comparing the interval (a+b+c) counted by the clock cycle to the expected length of two successive sync marks, for example, 22T for CD. The clock cycle is regulated base on the measurement of two sync marks in this embodiment, thus a higher resolution may be achieved in comparison with the previous embodiments.

Possible algorithms for determining the upper and lower slicing levels are listed in the following; however, numerous modifications and alterations of the proposed algorithms may be made while retaining the teachings of the invention.

1. A center level of the RF signal derived from the digital sum value (DSV) control is used for obtaining the upper and lower slicing levels. In an embodiment, the upper slicing level is determined by adding an offset to the center level, and similarly, the lower slicing level is acquired by subtracting an offset from the center level, where the offsets for acquiring the upper and lower slicing levels may be or may not be identical.

2. A peak value (absolute maximum value) and a bottom value (absolute minimum value) of the RF signal, for example, obtained from a peak hold/bottom hold method are used for deriving the upper and lower slicing levels. In an embodiment, the upper slicing level is acquired by subtracting an offset from the peak value, and the lower slicing level is acquired by adding an offset to the bottom value. Again, the two offsets may be or may not be identical. In another embodiment, the upper and lower slicing levels (USL and LSL) are obtained by averaging the peak value (PV) and bottom value (BV) based on some predetermined weightings. For example, USL=PV×0.75+BV×0.25; and LSL=PV×0.25+BV×0.75.

3. Both the center level as well as the peak and bottom values of the RF signal are used for deriving the upper and lower slicing levels. For example, the average of the peak value and the center level is designated as the upper slicing level, and the average of the bottom value and the center level is designated as the lower slicing level.

Those skilled in the art would understand that the listed algorithms are only a few of the possible methods, and various modifications could be made to determine the upper and lower slicing levels.

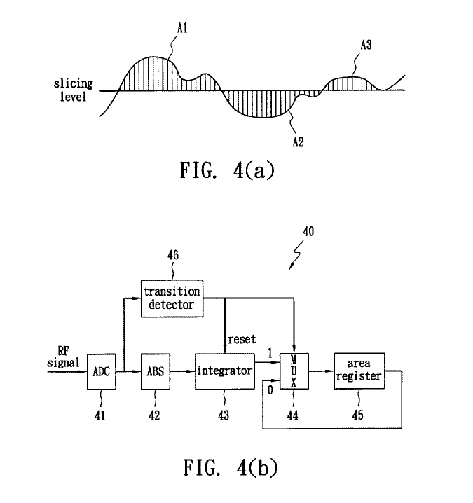

FIG. 4(a) illustrates an exemplary area integration method for detecting the frequency of the RF signal read from an optical disc. The RF signal forms a plurality of closed regions, for examples, regions A1, A2, and A3, with a slicing level. Among regions A1, A2, and A3, the largest area, for example, region A2, obtained by integration is regarded as a reference to the maximum run-length duration. Similar to the previous embodiments, if the counted number of clock cycle (T) corresponding to region A2 is less than the sync mark duration in terms of T, the frequency of the clock signal should be heightened; else the frequency should be lowered. Furthermore, if region A1 is approximate to region A2, an average of the two regions may be regarded as a reference to the maximum run-length duration. FIG. 4(b) shows a block diagram of an area integral circuit 40 for realizing the area integral method. The RF signal read from an optical disc is transformed from analog to digital in advance by an analog-to-digital converter (ADC) 41. The digitalized signal input to an absolute circuit 42 and an integrator 43 for calculating the area of each closed region. When the RF signal intersects the slicing level, a transition detector 46 senses such transition occurrence and reset the integrator 43 to start a new integral operation. Meanwhile, the transition detector 46 enables a multiplexer (MUX) 44 to store a current integral result to an area register 45.

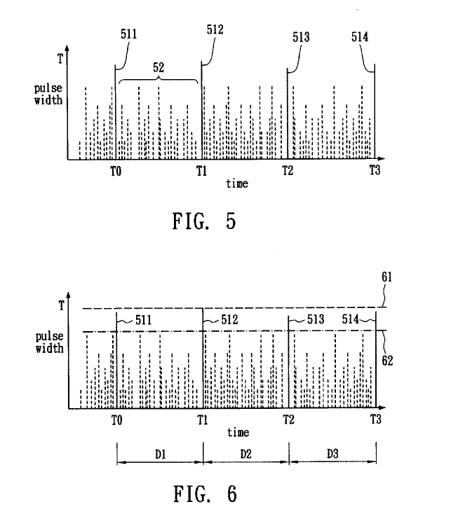

To improve the resolution of frequency detection methods, the system may record the position (such as the occurring time of the rising edge) of each pulse with a maximum pulse width, check if the recorded pulse occur periodically, and determine the frequency of the input signal by calculating the period of the regular periodical pulses. FIG. 5 is a pulse-width versus time graph in accordance with an embodiment of the frequency detection method. The maximum pulse width (for example, 11T for CD) of each frame should occur in the sync mark, and therefore, the occurrence of the maximum pulse width should be periodical with a period approximately equal to a frame length. For example, when a first maximum pulse 511, second maximum pulse 512, third maximum pulse 513, and fourth maximum pulse 514 occur periodically (at time T0, T1, T2, and T3 respectively), the time difference between two adjacent maximum pulses, for example time gap 52 between pulses 511 and 512, is an estimation to the length of a frame. Here provided several methods capable of determining the period of maximum pulses.

As shown in FIG. 6, pulse 512 with a maximum pulse width is obtained by comparing all the pulse widths over a predetermined time period. A preset threshold 62 is derived from the maximum pulse width 61, for example, the pulse width of pulse 512. If interval D1 between the first maximum pulse 511 and the second maximum pulse 512 is roughly equal to interval D2 between the second maximum pulse 512 and the third maximum pulse 513, a pseudo-frame period may be derived from interval D1 and/or interval D2 counted by the clock signal. Furthermore, the pseudo-frame period can be confirmed by comparing interval D3 with intervals D1 and D2. If the pseudo-frame period is not identical to the expected frame period, the frequency of the clock signal is then adjusted to minimize the difference thereof. In some embodiments, the expected frame period is 588 clock cycles for CD and 1488 clock cycles for DVD.

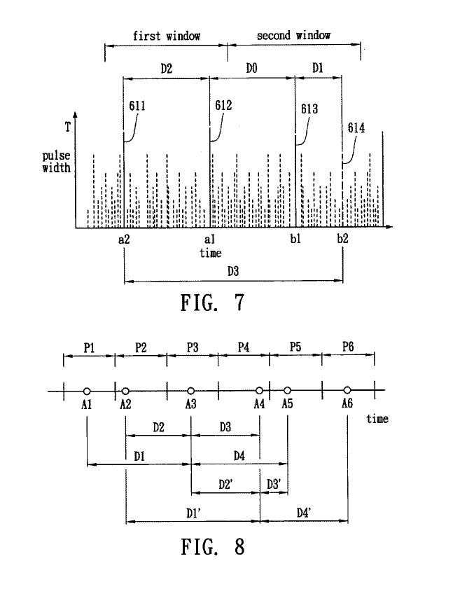

Beside the frequency detection method based on determination utilizing a preset threshold, another embodiment determines the frame period by first detecting two pulses within each window, one with the longest pulse width and another with the second longest pulse width, as shown in FIG. 7. In this embodiment, the window size is set between 1 to 2 times the expected frame period, for example, set window size as 589T-1175T for CD with a frame size of 588T. Such a window size ensures at least one, but no more than two sync marks are detected in each window. In an embodiment, the window size is set to be 1.5 times the expected frame period. As shown in FIG. 7, pulses 612 and 611 with longest and second longest pulse widths are detected in the first window at time a1 and a2 respectively. Similarly, in the second window, pulses 613 and 614 with longest and second longest pulse widths are detected at time b1 and b2 respectively. A first interval between b1 and a1 is denoted as D0, a second interval between b2 and b1 is denoted as D1, a third interval between a1 and a2 is denoted as D2, and a fourth interval between b2 and a2 is denoted as D3. The pseudo-frame period can be determined according to relations between intervals D0, D1, D2, D3 and the window size.

If interval D0 falls between 1 and 0.5 times the window size (win_size/2<D0<win_size), D0 is likely to be the pseudo-frame period. To further confirm that D0 is the pseudo-frame period, both the absolute difference between D1 and D0 |D1−D0| and absolute difference between D2 and D0 |D2−D0| are checked.

If interval D0 exceeds the window size (D0>win_size), the following cases illustrate the method for determining the pseudo-frame period.

Case 1: if D1 is approximately equal to a half of D0, then a half of D0 or D1 is likely to be the pseudo-frame period.

Case 2: if D2 is approximately equal to a half of D0, then a half of D0 or D2 is likely to be the pseudo-frame period.

Case 3: if both D1 and D2 are approximately equal to D3, any of D1, D2, or D3 is likely to be the pseudo-frame period.

Case 4: as a prerequisite for D0 larger than the window period, if D1 is approximately equal to a half of D0 (or the absolute value of a half of D0 subtracted by D1 is smaller than a preset value approaching zero), then a half of D0 or a half of D1 is likely to be the pseudo-frame period.

Case 5: as a prerequisite for D0 larger than the window period, if D2 is approximately equal to a half of D0 (or the absolute value of a half of D0 subtracted by D2 is smaller than a preset value approaching zero), then a half of D0 or a half of D2 is likely to be the pseudo-frame period.

Case 6: as a prerequisite for D0 larger than the window period, if D2 is approximately equal to D3 (or the absolute value of D2 subtracted by D3 is smaller than a preset value approaching zero), then D2 or D3 is likely to be the pseudo-frame period.

Case 7: as a prerequisite for D0 larger than the window period, if D1 is approximately equal to D3 (or the absolute value of D1 subtracted by D3 is smaller than a preset value approaching zero), then D1 or D3 is likely to be the pseudo-frame period.

FIG. 8 is a detected pulse sequence diagram illustrating an embodiment of the frequency detection method. As shown in FIG. 8, six pulses A1, A2, A3, A4, A5, and A6, each is detected as having a maximum pulse width in a corresponding window P1, P2, P3, P4, P5, and P6. The window size in this embodiment is between 1 and 0.5 times the expected frame period, for example, 0.75 times the expected frame period. The first five pulses occur respectively at time A1, A2, A3, A4, and A5 in sequence, and these occurring times are stored in a memory. A first interval between A3 and A1 is denoted as D1; a second interval between A3 and A2 is denoted as D2; a third interval between A4 and A3 is denoted as D3; and a fourth interval between A5 and A3 is denoted as D4. If one of the four absolute values: D1 subtracted by D3 |D1−D3|, D1 subtracted by D4 |D1−D4|, D2 subtracted by D3 |D2−D3|, or D2 subtracted by D4 |D2−D4|, is smaller than a threshold value, A3 is detected as a sync-mark occurring time. The smallest absolute value among the four absolute values can be utilized for deriving the pseudo-frame period.

Similarly, the next pulse with a maximum pulse width is further detected within window P6. A subsequent first interval between A4 and A2 is denoted as D1′; a subsequent second interval between A4 and A3 is denoted as D2′; a subsequent third interval between A5 and A4 is denoted as D3′; and a subsequent fourth interval between A6 and A4 is denoted as D4′. If one of the four absolute values: D1′ subtracted by D3′|D1′−D3′|, D1′ subtracted by D4′|D1′−D4′|, D2′ subtracted by D3′|D2′−D3′|, or D2′ subtracted by D4′|D2′−D4′|, is smaller than a threshold value, A4 is detected as the sync-mark occurring time. The interval between A3's occurring time and A4's occurring time should be the pseudo-frame period.

If a derived pseudo-frame period is not within 0.75 and 1.5 times the expected frame period, the derived pseudo-frame period should be ignored using a low pass filter (LPF) or a moving average method.

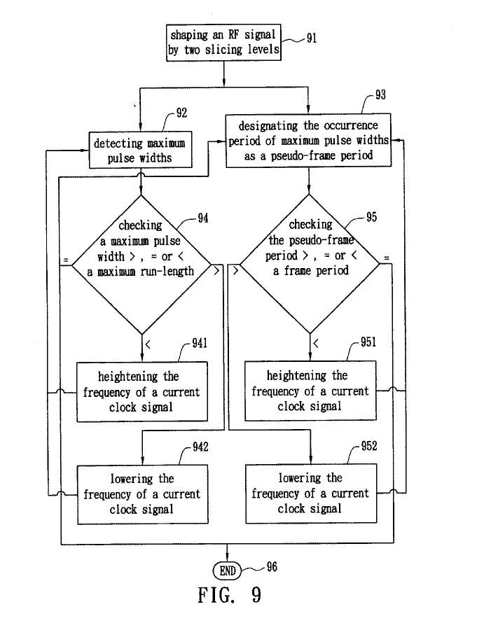

Finally, an embodiment of combining the aforesaid methods can be briefly summarized in a flow chart shown in FIG. 9. In Step 91, an RF signal is shaped by two slicing levels into two sliced signals. Pulses with maximum pulse width within each predetermined period are detected in Step 92. In Step 94, if the detected maximum pulse width is equal to the duration of a maximum run-length, the frequency detection process either terminates or enters Step 93 to improve clock cycle accuracy. When the detected maximum pulse width is smaller than the maximum run-length, the frequency of the clock signal is heightened; when the detected maximum pulse width is larger than the maximum run-length, the frequency of the clock signal is lowered, as shown in Step 941 and Step 942 respectively. In step 93, the period of pulses with maximum pulse widths is detected and designated as a pseudo-frame period. It is worthy to notice that conventionally methods such as single-level slicing are also applicable for determining the pseudo-frame period in Step 93. If the pseudo-frame period is equal to an expected frame period, the frequency detection process is terminated, as shown in Step 96. When the pseudo-frame period is smaller than the expected frame period, the frequency of the clock signal is heightened; when the pseudo-frame period is larger than the expected frame period, the frequency of the clock signal is lowered, as shown in Step 951 and Step 952 respectively.

The above-described embodiments of the present invention are intended to be illustrative only. Numerous alternative embodiments may be devised by persons skilled in the art without departing from the scope of the following claims.

What is claimed as new and desired to be protected by Letters Patent of the United States is:

1. A frequency detection method for a radio frequency (RF) signal read from an optical disc, comprising the steps of:
determining an upper slicing level and a lower slicing level;
deriving an upper sliced signal by slicing the RF signal according to the upper slicing level;
deriving a lower sliced signal by slicing the RF signal according to the lower slicing level;
detecting and deriving a first maximum pulse width occurring in the upper sliced signal or the lower sliced signal during a predetermined period; and
comparing the first maximum pulse width counted by a clock signal to a predetermined pulse width.

2. The frequency detection method of claim 1, further comprising the steps of:
heightening the frequency of the clock signal if the first maximum pulse width is shorter than the predetermined pulse width; and
lowering the frequency of the clock signal if the first maximum pulse width is longer than the predetermined pulse width.

3. The frequency detection method of claim 1, further comprising the steps of:
detecting a second maximum pulse width in the upper sliced signal or the lower sliced signal;
comparing an interval between the start of the first maximum pulse width and the end of the second maximum pulse width to two times the predetermined pulse width when a time gap between the first and second maximum pulse widths is less than a first threshold, and a difference between the first and second maximum pulse widths is less than a second threshold; and
adjusting the frequency of the clock signal according to the comparison result.

4. The frequency detection method of claim 1, wherein the predetermined pulse width is determined by the duration of a synchronization mark.

5. The frequency detection method of claim 1, wherein the predetermined period is between 2 to 4 times a frame period.

6. The frequency detection method of claim 1, wherein the upper slicing level and lower slicing level are derived from digital sum value (DSV) control.

7. The frequency detection method of claim 1, wherein the upper slicing level and lower slicing level are from a peak and bottom value of the RF signal.

8. The frequency detection method of claim 1, further comprising the steps of:
detecting the occurring time of pulses with a pulse length determined as the longest pulse width in each window over at least two windows;
checking whether the detected pulses occur periodically; and
designating an interval between two detected pulses as a pseudo-frame period if the aforesaid check is affirmative.

9. The frequency detection method of claim 8, further comprising the step of:
adjusting the frequency of the clock signal according to the pseudo-frame period.

10. The frequency detection method of claim 8, further comprising the steps of:
detecting the occurring time of pulses with a pulse length determined as a second longest pulse width in each window over at least two windows;
wherein the second longest pulse width is less than or equal to the longest pulse width, and the window size is greater than a frame period and less than two frame periods;
selecting the pulses separated by about the same distance by calculating and comparing differences between the detected occurring times corresponding to the longest and second longest pulse widths; and
deriving the pseudo-frame period according to the occurring times of the selected pulses.

11. The frequency detection method of claim 8, wherein the window is between one and a half of the frame period.

12. The frequency detection method of claim 8, further comprising the step of:
confirming the pseudo-frame period by a low pass filter (LPF) or a moving average method.

13. A frequency detection method for a radio frequency (RF) signal read from an optical disc, comprising the steps of:
determining a slicing level;
forming a plurality of closed regions by slicing the RF signal with the slicing level;
detecting a first maximum area among the closed regions during a predetermined period;
comparing a duration corresponding to the first maximum area counted by a clock signal to a predetermined interval; and
adjusting the frequency of the clock signal according to the comparison result.

14. The frequency detection method of claim 13, wherein the predetermined interval is determined by the duration of a synchronization mark.

15. The frequency detection method of claim 13, further comprising the step of:
detecting the occurring time of the closed regions with an area determined as the maximum area over at least two predetermined periods;
checking whether the detected occurring time is periodically; and
designating an interval between two detected positions as a pseudo-frame period if the aforesaid check is affirmative.

16. A frequency detection method for a radio frequency (RF) signal read from an optical disc, comprising:
detecting the occurring time of pulses with a pulse length determined as the longest pulse width in each window over at least two windows;
checking whether the detected pulses occur periodically; and
designating an interval between two detected pulses as a pseudo-frame period if the aforesaid check is affirmative.

17. The frequency detection method of claim 16, further comprising the step of:
adjusting the frequency of the clock signal according to the pseudo-frame period.

18. The frequency detection method of claim 16, further comprising the steps of:
detecting the occurring time of pulses with a pulse length determined as the second longest pulse width in each window over at least two windows; wherein the second longest pulse width is less than or equal to the longest pulse width, and the window size is greater than a frame period and less than two frame periods;
selecting the pulses separated by about the same distance by calculating and comparing differences between the detected occurring times corresponding to the longest and second longest pulse widths; and
deriving the pseudo-frame period according to the occurring times of the selected pulses.

19. The frequency detection method of claim 16, wherein the window is between one and a half of the frame period.

20. The frequency detection method of claim 16, further comprising the step of:
confirming the pseudo-frame period by a low pass filter (LPF) or a moving average method.
